(19) United States
(12) Patent Application Publication
(10) Pub. No.: US 2012/0146535 A1
(43) Pub. Date: Jun. 14, 2012

(54) LED CONTROLLER ASIC AND PWM MODULE THEREOF

(75) Inventors: SHIH MING LEE, TAIPEI CITY (TW); HONG CHE YEN, HSINCHU COUNTY (TW); WEN LIN KAO, HSINCHU COUNTY (TW); YUNG FU CHEN, HSINCHU COUNTY (TW); TZAI DE LIN, TAINAN CITY (TW)

(73) Assignee: GOYATEK TECHNOLOGY INC., HSIN-CHU (TW)

(21) Appl. No.: 12/963,871

(22) Filed: Dec. 9, 2010

(51) Int. Cl. H05B 41/24

(52) U.S. Cl. 315/250

(57) ABSTRACT

An LED controller application specific integrated circuit includes a host interface and a PWM module. The PWM module is configured to control a plurality of LED devices, and comprises a PWM data buffer, an arithmetic core and a plurality of PWM channels. The PWM data buffer is configured to store PWM turning-point data from the host. The arithmetic core is configured to generate PWM data according to the PWM turning-point data stored in the PWM data buffer. The plurality of PWM channels are configured to receive the PWM data, and each comprises a PWM controller and a PWM I/O interface. The PWM controller is configured to control the operation of the PWM channel. The PWM I/O interface is configured to connect to an LED device.

### BACKGROUND OF THE INVENTION

1. Field of the Invention

The present invention relates in general to LED devices, and more particularly to circuitry for controlling a plurality of LED devices.

2. Description of the Related Art

Compared to conventional light emitting devices, LED devices consume less power, have longer lifetimes and are more durable. Therefore, most indicator devices produced nowadays, such as traffic signs and commercial billboards, are implemented by LED devices. Currently, LED devices can also be found in mobile phone applications, where the LEDs serve functions such as indicators or backlight devices. For such applications, pulse width modulation (PWM) is often used as the pattern for the driving of the LED devices.

When used in mobile phone applications, an LED controller is often required. FIG. 1 shows a conventional LED controller system used in mobile phone applications. The LED controller system 100 comprises a host 102, a microprocessor 104 and a plurality of LED devices 106. The host 102 is connected to the microprocessor 104 via an inter integrated circuit (I²C) interface. During operation, the host 102 outputs PWM turning-point data to the microprocessor 104. The microprocessor 104 generates PWM data by interpolation according to the PWM turning-point data and controls the operation of the LED devices 106 according to the PWM data. As shown in FIG. 2, the PWM turning-point data are provided by the host 102, and the other PWM data are generated by the microprocessor 104. However, there are some disadvantages to the LED controller system 100 shown in FIG. 1. First, even though only some of the functions of the microprocessor 104 are being used, a full power supply to the microprocessor 104 is still required. Accordingly, more energy is spent than needed. In addition, since only some the functions of the microprocessor 104 are being used, more hardware size is occupied than is required. Furthermore, when the plurality of LED devices 106 are required to be driven simultaneously, a synchronization problem arises.

FIG. 3 shows another conventional LED controller system used in mobile phone applications. The LED controller system 200 comprises a host 202 and a plurality of LED devices 206. In the LED controller system 200, the microprocessor is omitted, and the host 202 is directly connected to the plurality of LED devices 206 via a general purpose input output (GPIO) interface. Even though the LED controller system 200 has smaller hardware size and lower power consumption compared to the LED controller system 100 shown in FIG. 1, there are still some disadvantages to the LED controller system 200 shown in FIG. 3. First, the LED controller system 200 still suffers from the synchronization problem when the pluralities of LED devices 206 are required to be driven simultaneously. In addition, since PWM data are entirely generated by the host 202, greater firmware workloads are required and more test and verification are needed.

Therefore, there is a need to design a new method of controlling LED devices that does not have the disadvantages of the conventional LED controller systems.

### SUMMARY OF THE INVENTION

The LED controller application specific integrated circuit (ASIC) according to one embodiment of the present invention comprises a host interface and a PWM module. The host interface is configured to connect to a host. The PWM module is configured to control a plurality of LED devices, and comprises a PWM data buffer, an arithmetic core and a plurality of PWM channels. The PWM data buffer is configured to store PWM turning-point data from the host. The arithmetic core is configured to generate PWM data according to the PWM turning-point data stored in the PWM data buffer. The plurality of PWM channels are configured to receive the PWM data, and each comprises a PWM controller and a PWM I/O interface. The PWM controller is configured to control the operation of the PWM channel. The PWM I/O interface is configured to connect to an LED device.

The PWM module in an LED controller circuit for controlling a plurality of LED devices according to one embodiment of the present invention comprises a PWM data buffer, an arithmetic core and a plurality of PWM channels. The PWM data buffer is configured to store PWM turning-point data from a host. The arithmetic core is configured to generate PWM data according to the PWM turning-point data stored in the PWM data buffer. The plurality of PWM channels are configured to receive the PWM data, and each comprises a PWM controller and a PWM I/O interface. The PWM controller is configured to control the operation of the PWM channel. The PWM I/O interface is configured to connect to an LED device.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon referring to the accompanying drawings of which:

FIG. 1 shows a conventional LED controller system in mobile phone applications;

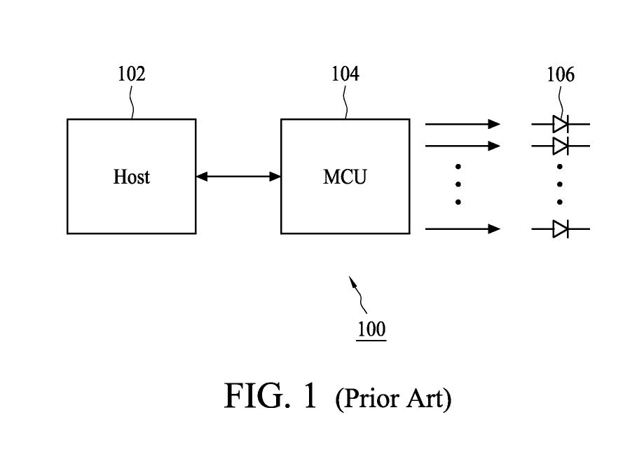

FIG. 2 shows PWM data provided by a conventional LED controller system in mobile phone applications;

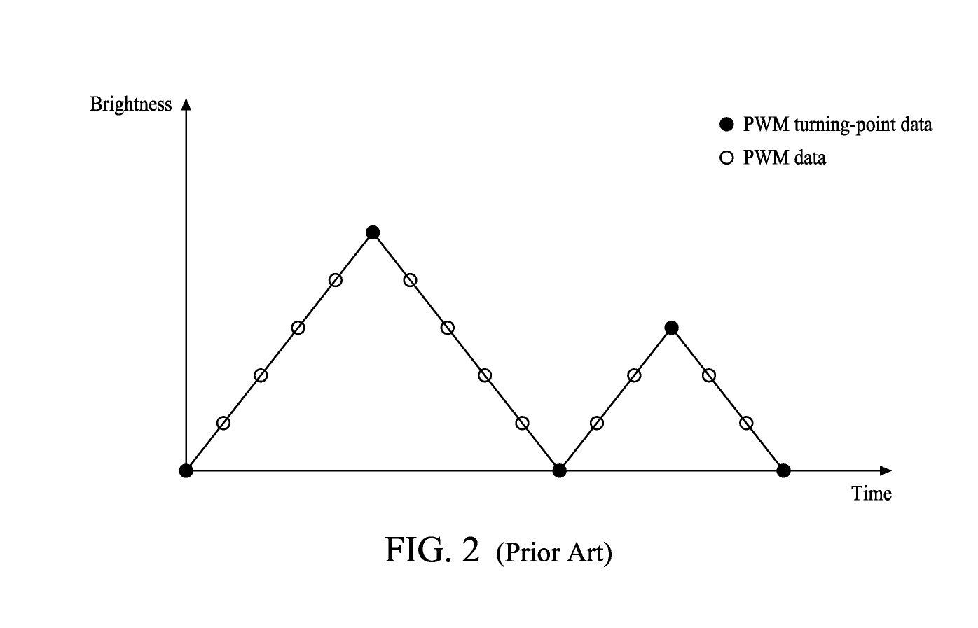

FIG. 3 shows another conventional LED controller system in mobile phone applications;

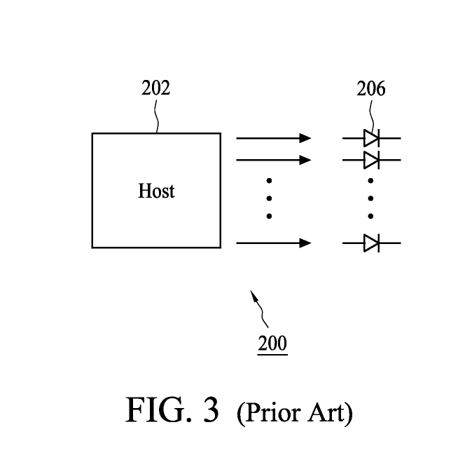

FIG. 4 shows an LED controller ASIC according to one embodiment of the present invention;

FIG. 5 shows a schematic view of a PWM module according to one embodiment of the present invention;

FIG. 6 shows a block diagram of a main state machine of a PWM channel when operated under a normal mode according to one embodiment of the present invention;

FIG. 7 shows a block diagram of a slave state machine of a PWM channel when operated under a sleep mode according to one embodiment of the present invention;

FIG. 8 shows a block diagram of a reset circuit according to one embodiment of the present invention;

FIG. 9 shows a waveform of a reset interrupt and a reset signal outputted by a reset circuit according to one embodiment of the present invention;

FIG. 10 shows a waveform of a reset interrupt and a reset signal outputted by a reset circuit according to another embodiment of the present invention;

FIG. 11 shows a block diagram of a clock correct circuit according to one embodiment of the present invention; and

FIG. 12 shows the relationship between a clock signal CLK1 and a clock signal CLK2 according to one embodiment of the present invention.

### DETAILED DESCRIPTION OF THE INVENTION

The embodiments of the present invention use ASICs to implement the LED controller circuits. Since the ASIC comprises only the required circuitry of the LED controller circuit, no additional power or hardware size are wasted. In addition, since the LED controller ASICs according to the embodiments of the present invention comprise a plurality of PWM channels, each of which is configured to control a respective LED device, the synchronization problem can be eliminated.

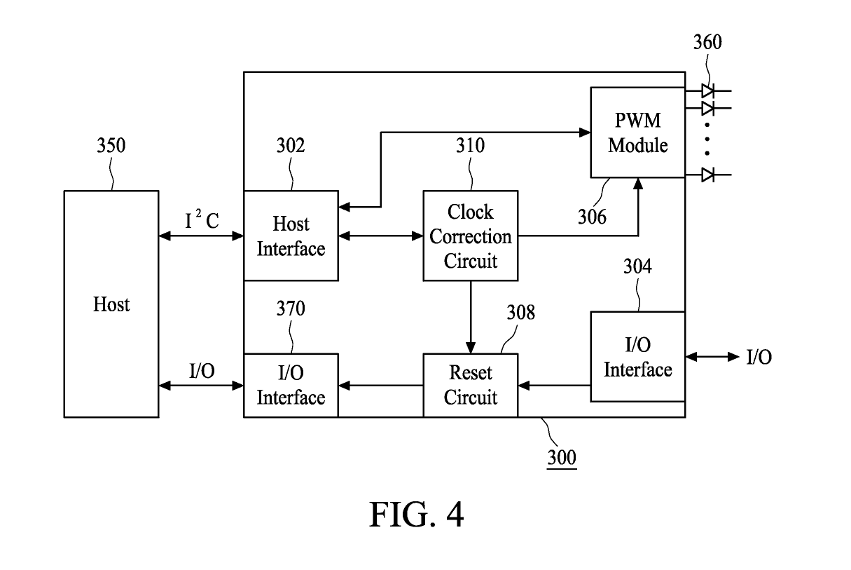

FIG. 4 shows an LED controller ASIC according to one embodiment of the present invention. As shown in FIG. 4, the LED controller ASIC 300 comprises a host interface 302, an I/O interface 304 and a PWM module 306. The LED controller ASIC 300 is connected to a host 350 through the host interface 302, and is connected to a plurality of LED devices 360 through the PWM module 306. The PWM module 306 is configured to control the plurality of LED devices 360. In some embodiments of the present invention, the host interface 302 comprises an I²C interface configured to receive serial data and clock input from the host 350.

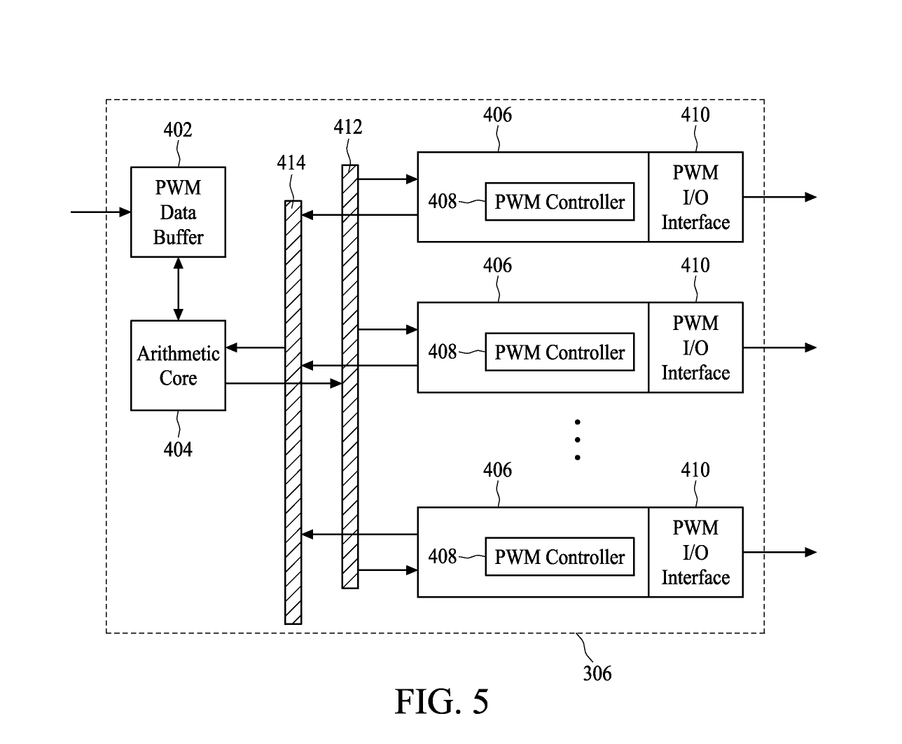

FIG. 5 shows a schematic view of the PWM module 306. As shown in

FIG. 5, the PWM module 306 comprises a PWM data buffer 402, an arithmetic core 404 and a plurality of PWM channels 406. The PWM data buffer 402 is configured to store PWM turning-point data from the host 302. The arithmetic core 404 is configured to generate PWM data according to the PWM turning-point data stored in the PWM data buffer 402. The plurality of PWM channels 406 are configured to receive the PWM data. Each of the plurality of PWM channels 406 comprises a PWM controller 408 and a PWM I/O interface 410. The PWM controller 408 is configured to control the operation of the PWM channel 406. The PWM I/O interface 410 is configured to connect to one of the LED devices 360.

As shown in FIG. 5, the PWM data buffer 402, which may be implemented by registers, an SRAM or any other memory device, is configured to receive PWM turning-point data from the host 302. The arithmetic core 404 outputs the PWM data to the plurality of PWM channels 406 via a bus 412. The plurality of PWM channels 406 issue interrupt signals to the arithmetic core 404 via another bus 414. When one of the PWM channels 406 requires PWM data, the PWM channel 406 issues an interrupt signal to the arithmetic core 404. Accordingly, the arithmetic core 404 retrieves the corresponding PWM turning-point data from the PWM data buffer 402 to generate the PWM data. When a plurality of interrupt signals are received by the arithmetic core 404 simultaneously, the arithmetic core 404 retrieves corresponding PWM turning-point data from the PWM data buffer 402 and generates PWM data in accordance with the priority levels of the plurality of interrupt signals. As can be seen from FIG. 5, the PWM module 306 comprises a plurality of PWM channels 406. Accordingly, a plurality of PWM signals can be processed simultaneously, and thus the synchronization problem can be solved.

In some embodiments of the present invention, each of the PWM channels 406 comprises a state machine, and can be operated under a normal mode or a sleep mode, wherein the mode of each PWM channel 406 is determined by instructions issued by the host 350. Each PWM channel 406 operated in a normal mode is configured to output PWM data and control the operation of the LED device 360 connected to the PWM I/O interface 410 of the PWM channel 406. Each PWM channel 406 operated in the sleep mode is configured to resume its original state after a predetermined time.

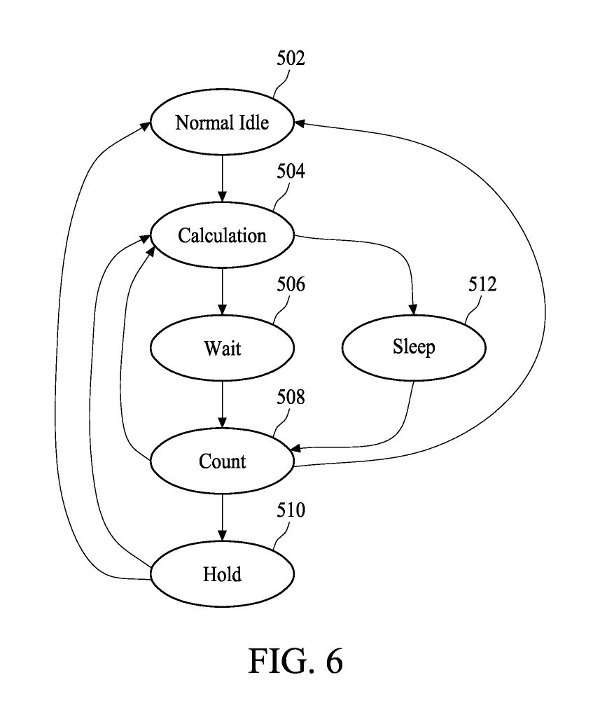

FIG. 6 shows a block diagram of the main state machine of a PWM channel 406 when operated under a normal mode. In state 502, the normal idle state, the PWM channel 406 is idle until receiving an instruction issued by the host 350. If an instruction is received, the PWM channel 406 enters state 504. In state 504, the calculation state, the arithmetic core 404 retrieves PWM turning point data from the PWM data buffer 402 and generates PWM data for the PWM channel 406. Next, if a sleep instruction is received, the PWM channel 406 enters sleep mode 512; otherwise, the PWM channel 406 enters state 506. In state 506, the wait state, the PWM I/O interface 410 of the PWM channel 406 loads the PWM data to the LED device 360 connected to the PWM I/O interface 410 of the PWM channel 406. If the load process is finished, the PWM channel 406 enters state 508. In state 508, the count state, the PWM channel 406 maintains its PWM data for a predetermined time. After the predetermined time, if a new instruction from the host 350 is received, the PWM channel 406 enters state 502; if the PWM channel 406 is configured to repeat the output of the PWM data, the PWM channel 406 enters state 510; otherwise, the PWM channel 406 enters state 504. In state 510, the hold state, the PWM channel 406 holds its PWM signal until receiving a new instruction issued from the host 350. If a new instruction, e.g. a stop instruction, is received, the PWM channel 406 enters state 502. If a new instruction for the PWM channel 406 to change the pattern of the output PWM data, the PWM channel 406 enters state 504.

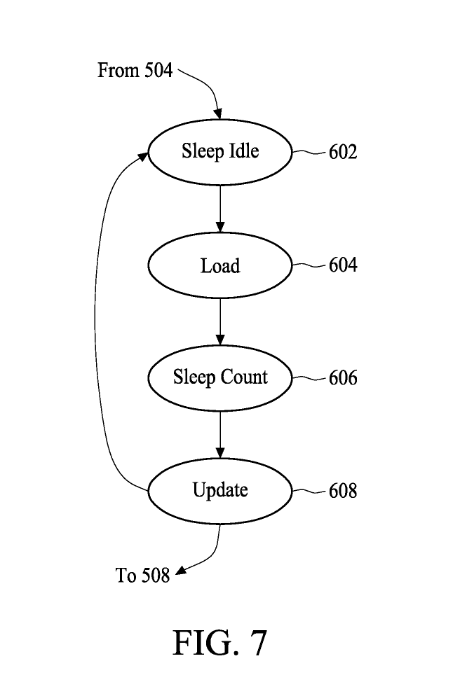

FIG. 7 shows a block diagram of the slave state machine of a PWM channel 406 when operated under a sleep mode, which corresponds to the sleep mode 512 of the main state machine shown in FIG. 6. State 602 is the sleep idle state. When the main state machine enters state 512 the PWM channel 406 enters state 604 of the slave state machine. In state 604, the load state, the PWM channel 406 loads a counter value, and then the PWM channel 406 enters state 606. In state 606, the sleep count state, the PWM channel 406 counts until the counter value is reached, and then the PWM channel 406 enters state 608. In state 608, the update state, the PWM channel 406 updates its state, and then the slave state machine of the PWM channel 406 returns to state 602, and the PWM channel 406 leaves the sleep mode 512 and enters the state 508.

In addition to the generation of the PWM signals, the LED controller ASIC 300 may also be required to reset the host 350 when a reset signal is received. Traditionally, a user can use a needle to press a reset button to reset a mobile phone. This reset mechanism is not convenient for users.

In some embodiments of the present invention, the LED controller ASIC 300 may further comprise a reset circuit 308, as shown in FIG. 4. As shown in FIG. 4, the reset circuit 308, which can transmit signal to the host 350 via another 10 interface 370, is configured to issue a reset interrupt when receiving a reset signal from the I/O interface 304 and then issue a reset signal output after the issue of the reset interrupt. In addition, a predetermined time interval passes between the issues of the reset interrupt and the reset signal output. In some embodiments of the present invention, the reset signal may be a combination of input signals, such as three keypads pressed in a predetermined order.

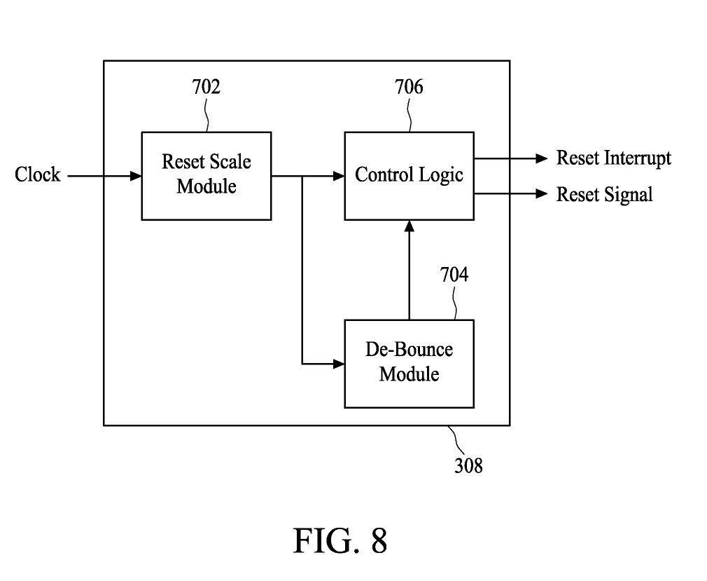

FIG. 8 shows the block diagram of the reset circuit 308. As shown in FIG. 8, the reset circuit 308 comprises a reset scale module 702, a de-bounce module 704 and a control logic 706. The reset scale module 702 is configured to provide a frequency division signal of a clock signal. The de-bounce module 704 is configure to smooth the input signal or the combination of input signals with the sampling rate determined by the frequency division signal. The control logic 706 is configured to issue the reset interrupt and the reset signal.

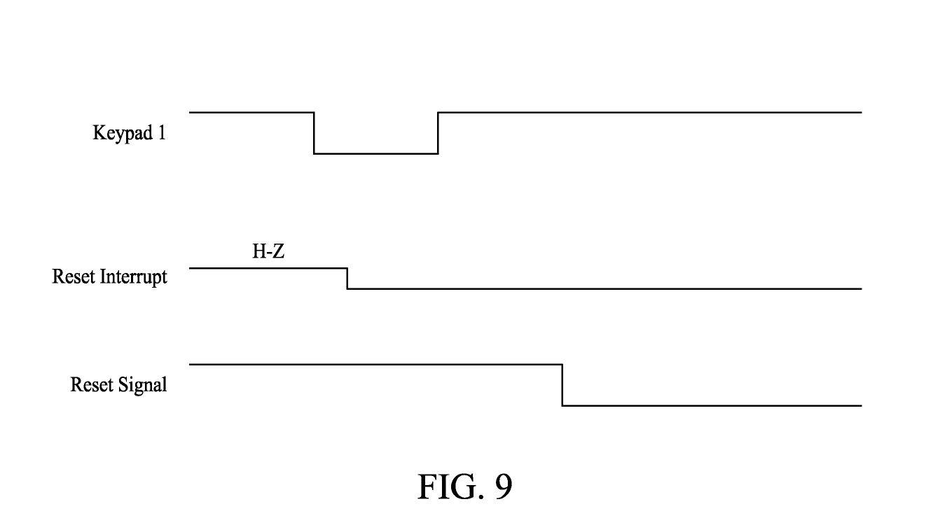

FIG. 9 shows a waveform of the reset interrupt and the reset signal outputted by the reset circuit 308 according to one embodiment of the present invention. In this embodiment, the reset signal is an input of a keypad 1. As shown in FIG. 9, after the keypad 1 is pressed, the reset interrupt is activated. Upon receiving the reset interrupt, the host 350 may transfer its data that is in volatile memory to non-volatile memory. After a predetermined time, the reset signal is activated, and thus the LED controller ASIC 300 and the host 350 are reset.

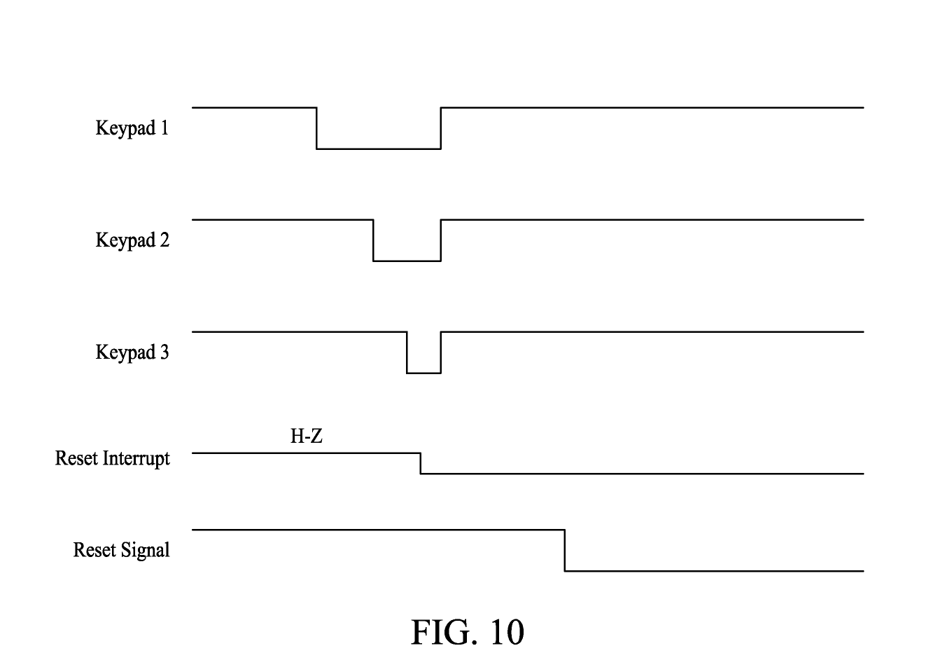

FIG. 10 shows a waveform of the reset interrupt and the reset signal outputted by the reset circuit 308 according to another embodiment of the present invention. In this embodiment, the reset signal is a combination of keypads 1, 2, and 3. As shown in FIG. 10, after keypads 1, 2, and 3 are pressed in sequence, the reset interrupt is activated, and the reset signal is activated after a predetermined time.

Traditionally, the clock rate of an ASIC may be calibrated by connecting the internal clock generated by the ASIC to an external resistor. However, for applications in which the pins are extremely valuable, the additional pins to connect to an external resistor may not be available.

In some embodiments of the present invention, the LED controller ASIC 300 may further comprise a clock correct circuit, as shown in FIG. 4. As shown in FIG. 4, the clock correct circuit 310 is configured to calibrate an internal clock signal based on an external clock signal, which is much more accurate than the internal clock signal. In addition, the clock rate of the internal clock signal may be lower or higher than that of the external clock signal.

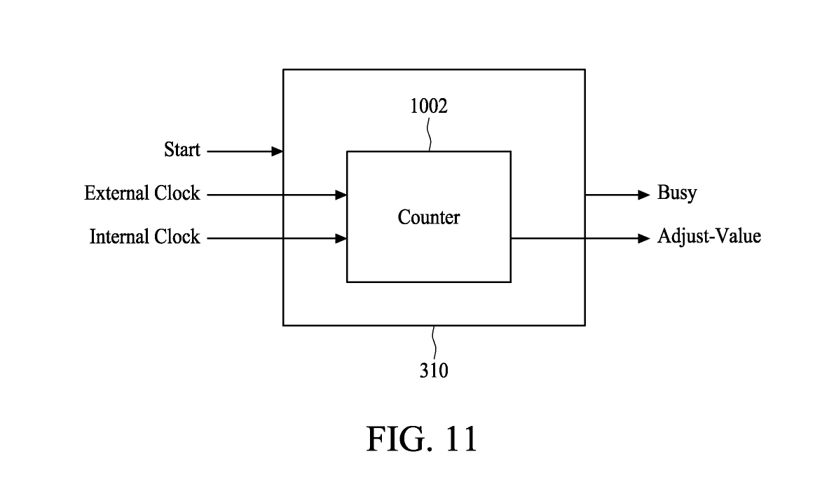

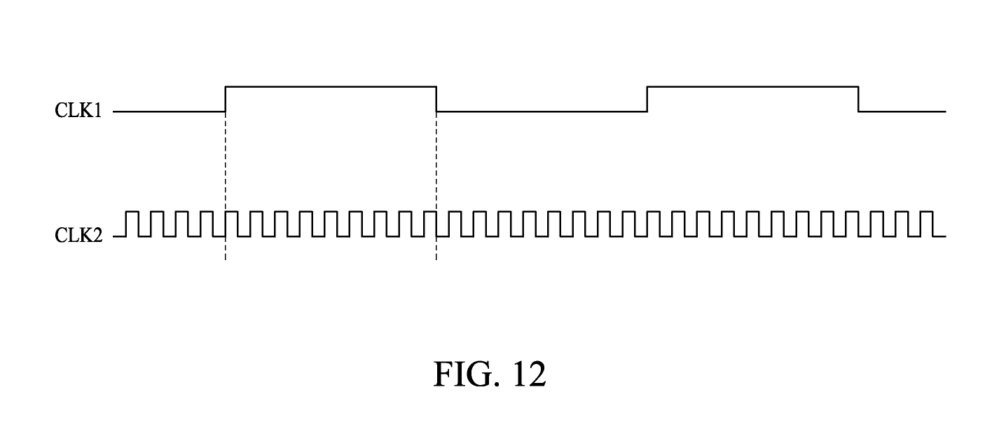

FIG. 11 shows the block diagram of the clock correct circuit 310. In this embodiment, the clock rate of the internal clock signal is higher than that of the external clock signal. As shown in FIG. 11, the clock correct circuit 310 comprises a counter 1002. The counter 1002 is configured to count the pulse number of the clock with higher clock rate, i.e. the external clock signal, within a pulse of the clock with lower clock rate, i.e. the internal clock signal, when receiving a start signal and output a busy signal accordingly. If the counted number is not within a predetermined range, which means the internal clock signal is either too fast or too slow, the adjusted value does not equal a predetermined value, and the clock correct circuit 310 then adjusts the clock rate of the internal clock signal according to the adjusted value. FIG. 12 shows the relationship between a clock signal CLK1 and a clock signal CLK2, wherein the clock rate of the clock signal CLK1 is lower than that of the clock signal CLK2. In some embodiments of the present invention, the clock rate of the internal clock signal is higher than that of the external clock signal; that is, the clock signal CLK1 is the external clock signal, and the clock signal CLK2 is the internal clock signal. As shown in FIG. 11, the clock correct circuit 310 uses an external clock signal, which is easily available in a mobile phone application, to calibrate an internal clock signal. Accordingly, the additional pins to connect to a resistor are not needed. In addition, the precision of the clock correction can be significantly improved.

In conclusion, the embodiments of the present invention use ASICs to implement the LED controller circuits. Since the ASIC comprises only the required circuitry of the LED controller circuit, no additional power or hardware size are wasted. In addition, since the LED controller ASICs according to the embodiments of the present invention comprise a plurality of PWM channels, each of which is configured to control an LED device, the synchronization problem can be eliminated. Furthermore, with the addition of the reset circuit and the clock correct circuit, the function of the LED controller ASIC provided by the embodiments of the present invention is more powerful, and therefore can be suited perfectly to mobile phone applications, such as to control an LED indicator or a backlight device of a mobile phone.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An LED controller ASIC, comprising:
a host interface, configured to connect to a host; and
a PWM module, configured to control a plurality of LED devices, comprising:
a PWM data buffer, configured to store PWM turning-point data from the host;
an arithmetic core, configured to generate PWM data according to the PWM turning-point data stored in the PWM data buffer; and
a plurality of PWM channels, configured to receive the PWM data, each comprising:
a PWM controller, configured to control the operation of the PWM channel; and
a PWM I/O interface, configured to connect to an LED device.

2. The LED controller ASIC of claim 1, wherein the host interface comprises an inter integrated circuit interface configured to receive serial data and clock input from the host.

3. The LED controller ASIC of claim 1, wherein each PWM channel is configured to issue an interrupt signal to the arithmetic core when the PWM channel is required to generate PWM data.

4. The LED controller ASIC of claim 3, wherein when a plurality of interrupt signals are received simultaneously, the arithmetic core is configured to retrieve corresponding PWM turning-point data from the PWM data buffer and generates PWM data in accordance with priority levels of the plurality of interrupt signals.

5. The LED controller ASIC of claim 1, wherein each PWM channel is operable in a normal mode in accordance with a first clock signal and a sleep mode in accordance with a second clock signal, and the clock rate of the first clock signal is higher than that of the second clock signal.

6. The LED controller ASIC of claim 5, wherein the mode of each PWM channel is determined by instructions issued by the host.

7. The LED controller ASIC of claim 6, wherein each PWM channel operated in the normal mode is configured to output PWM data and control the operation of the LED device connected to the PWM I/O interface of the PWM channel.

8. The LED controller ASIC of claim 7, wherein each PWM channel operated in the normal mode comprises the following states:
a normal idle state, in which the PWM channel is idle until receiving an instruction issued by the host;
a calculation state, in which the arithmetic core generates PWM data for the PWM channel;
a wait state, in which the PWM I/O interface of the PWM channel loads the PWM data to the LED device connected to the PWM I/O interface of the PWM channel;
a count state, in which the PWM channel maintains its PWM data after a predetermined time; and
a hold state, in which the PWM channel holds its PWM data until receiving an instruction issued by the host or after a predetermined time.

9. The LED controller ASIC of claim 6, wherein each PWM channel operated in the sleep mode is configured to resume its original state after a predetermined time.

10. The LED controller ASIC of claim 9, wherein each PWM channel operated in the sleep mode comprises the following states:
a sleep idle state, in which the PWM channel is idle for a predetermined time;
a load state, in which the PWM channel loads a counter value;
a sleep count state, in which the PWM channel counts until the counter value is reached; and
an update state, in which the PWM channel updates its state.

11. The LED controller ASIC of claim 1, wherein the PWM data buffer is implemented by registers or an SRAM.

12. The LED controller ASIC of claim 1, further comprising:
an I/O interface, configured to connect to I/O peripherals;
a reset circuit, configured to issue a reset interrupt when receiving a reset signal from the I/O interface and then issue a reset signal after the issue of the reset interrupt; and
wherein there is a predetermined time interval between the issuing of the reset interrupt and the issuing of the reset signal.

13. The LED controller ASIC of claim 12, wherein the reset signal is a combination of input signals.

14. The LED controller ASIC of claim 13, wherein the reset circuit comprises:
a reset scale module, configured to provide a frequency division signal of a clock signal;
a de-bounce module, configure to smooth the reset signal with the sampling rate determined by the frequency division signal; and
a control logic, configure to issue the reset interrupt and the reset signal.

15. The LED controller ASIC of claim 1, further comprising:
a clock correct circuit, configured to calibrate an internal clock signal based on an external clock signal.

16. The LED controller ASIC of claim 15, wherein the clock correct circuit comprises:
a counter, configured to count the pulse number of the clock signal with higher clock rate among the internal clock signal and the external clock signal within a pulse of the clock signal with lower clock rate among the internal clock signal and the external clock signal; and
wherein the clock correct circuit is configured to adjust the clock rate of the internal clock signal when the counted number is not within a predetermined range.

17. The LED controller ASIC of claim 1, being configured to control an LED indicator or a backlight device of a mobile phone.

18. A PWM module in an LED controller circuit for controlling a plurality of LED devices, comprising:
a PWM data buffer, configured to store PWM turning-point data from a host;
an arithmetic core, configured to generate PWM data according to the PWM turning-point data stored in the PWM data buffer; and
a plurality of PWM channels, configured to receive the PWM data, each comprising:
a PWM controller, configured to control the operation of the PWM channel; and
a PWM I/O interface, configured to connected to an LED device.

19. The PWM module of claim 18, wherein each PWM channel is configured to issue an interrupt signal to the arithmetic core when the PWM channel is required to generate PWM data.

20. The PWM module of claim 19, wherein when a plurality of interrupt signals are received simultaneously, the arithmetic core is configured to retrieve corresponding PWM turning-point data from the PWM data buffer and generates PWM data in accordance with priority levels of the plurality of interrupt signals.

21. The PWM module of claim 18, wherein each PWM channel is operable in a normal mode in accordance with a first clock signal and a sleep mode in accordance with a second clock signal, and the clock rate of the first clock signal is higher than that of the second clock signal.

22. The PWM module of claim 21, wherein the mode of each PWM channel is determined by instructions issued by the host.

23. The PWM module of claim 22, wherein each PWM channel operated in the normal mode is configured to output PWM data and control the operation of the LED device connected to the PWM I/O interface of the PWM channel.

24. The PWM module of claim 23, wherein each PWM channel operated in the normal mode comprises the following states:
a normal idle state, in which the PWM channel is idle until receiving an instruction issued by the host;
a calculation state, in which the arithmetic core generates PWM data for the PWM channel;
a wait state, in which the PWM I/O interface of the PWM channel loads the PWM signal to the LED device connected to the PWM I/O interface of the PWM channel;
a count state, in which the PWM channel maintains its PWM data after a predetermined time; and
a hold state, in which the PWM channel holds its PWM data until receiving an instruction issued by the host.

25. The PWM module of claim 22, wherein each PWM channel operated in the sleep mode is configured to resume its original state after a predetermined time.

26. The PWM module of claim 25, wherein each PWM channel operated in the sleep mode comprises the following states:
a sleep idle state, in which the PWM channel is idle for a predetermined time;
a load state, in which the PWM channel loads a counter value;
a sleep count state, in which the PWM channel counts until the counter value is reached; and
an update state, in which the PWM channel updates its state

27. The PWM module of claim 18, wherein the PWM data buffer is implemented by registers or an SRAM.

28. The PWM module of claim 18, being configured to control an LED indicator or a backlight device of a mobile phone.
